(19) United States
(12) Patent Application Publication
(10) Pub. No.: US 2007/0297358 A1
(43) Pub. Date: Dec. 27, 2007

(54) Efficient WLAN location in a wireless device

(76) Inventors: Henry S. Chang, San Diego, CA (US); Amit Kalhan, La Jolla, CA (US); Douglas L. Dunn, Chula Vista, CA (US); Julien Nicolas, San Diego, CA (US)

Correspondence Address: KYOCERA WIRELESS CORP., P.O. BOX 928289, SAN DIEGO, CA, 92192-8289, US

(21) Appl. No.: 11/472,943

(22) Filed: Jun. 22, 2006

(51) Int. Cl. H04Q 7/00

(52) U.S. Cl. 370/328

(57) ABSTRACT

A wireless communications device having a localized preferred roaming list (WLANL), the WLANL having location specific WLAN AP information associated with it. A mobile wireless device uses the information in the WLANL to manage active searches for WLAN APs. In addition, the WLANL information can be used to mange active sessions, enabling a switch from one air interface to another depending on which air interface is currently the most reliable, has bandwidth available, or other considerations.

### FIELD OF THE INVENTION

The present invention relates to the field of wireless communication devices. More specifically, the invention relates to the use of wireless local area network lists (WLANLs) for efficient location of wireless locals area networks (WLANs) in mobile wireless devices.

### BACKGROUND OF THE INVENTION

Wireless Local Access Networks (WLANs, WiFi) provide wireless access to data networks within a relatively small distance from WLAN access points (WLAN APs). These distances vary depending on the type of WLAN in use, e.g., 802.11a/b/g, but are typically in the range of fifty to one hundred meters. This limits service with WLANs to localized areas, such as inside a building or being in close physical proximity to a public WLAN AP (“WiFi Hot Spot”).

Multi-mode mobile wireless devices are being sold with both traditional and WLAN air interfaces. For cell phones, the air interfaces would typically include a wireless wide area network air interface, e.g., cdma2000, and a WLAN air interface. Currently, multi-mode mobile wireless devices that include a WLAN air interface expend substantial amounts of energy trying to locate a WLAN to obtain WLAN service. This is done by continually or periodically scanning for beacon signals from WLAN APs, or active probing. This repeated scanning and/or probing is energy intensive and significantly reduces battery life. Users of some multi-mode devices may manually turn off searching for WLAN APs to conserve battery life and chance missing a WLAN AP, or continue scanning in the hopes of finding the occasional WLAN AP that falls within the cell phone's scanning area. There is a need for better managing of, and increasing the efficiency of, the search for WLAN APs by mobile wireless devices.

### SUMMARY

The inventive concepts and apparatus disclosed herein includes a wireless local area network list (WLANL) in a mobile wireless device, where the WLANL is used in making decisions to search for wireless LAN access points (WLAN APs), and to manage active sessions between a wireless wide area network (WWAN) interface and a WLAN interface. In one embodiment, the mobile wireless device has a WLANL with entries for WLAN APs therein, where the entries have WLAN specific information or data. In one embodiment, the WLANL is localized in that it is specific to an area or regional location. The size of the area will depend on the environment in which the mobile wireless device is operating. In one embodiment the wireless device's location is determined and a WLANL associated with the location is checked for age related information. If the age of the WLANL (or an entry of interest in the WLANL) is found to be in an acceptable range, the WLANL is used to determine where to search for a WLAN AP. Rather than searching for a WLAN AP continually or at periodic intervals without knowledge of the possible existence of WLAN APs, the searches are carried out when there is a likelihood of a successful search.

Age information may be associated with the WLANL, with each WLANL entry, with data in an entry, or a combination. It is expected that higher-end implementations will store age related information at each level of granularity, including but not limited to the date and/or time the WLANL was created or downloaded and last modified, when an AP entry was created or modified, and date/time information associated with an AP's detection, use, and/or for which a searched was conducted. It is expected that lower-end implementations may have one date or date/time stamp associated with each WLANL, and perhaps one associated with each entry, but not associated with data inside an entry.

The WLANLs may be downloaded over an air interface, initialized or loaded at a carrier's storefront, or generated by the owner (user). Keeping a WLANL up-to-date may include adding entries that the mobile wireless device finds on its own, or which the mobile wireless device's user specifically adds to a user-defined and controlled WLANL. The latter case may occur, for example, when the owner knows of a private WLAN AP. The owner may manually trigger the mobile wireless device to do a WLAN AP search, and the mobile wireless device will add a detected AP to the user-defined WLANL. The mobile wireless device may also have a user interface that allows manual creation of a WLANL entry.

The area assigned to the WLANL (“area”) and the location of the mobile wireless device (“location”) need not exactly overlap; rather, if the area and location are deemed to be close enough, a best-matched WLANL is used. The determination of what is a best-match will vary by implementation. Some implementations will require that the location be inside the area associated with the WLANL. Others will use WLANLs based on the cell or cells to which the mobile wireless device is communicating, and let the mobile wireless device decide what information from the WLANL is useful. Other implementations may define “close enough” to include areas covered by entries in a WLANL that are partially inside and partially outside a current location. The area of the WLANL may also correspond to a projected location: where the mobile wireless device is headed.

The information or data in a WLAN AP entry will vary by implementation, but may include WLAN AP SSIDs, AP frequencies, AP authentication information, AP authorization information, WLAN service provider login and password, WLAN type information, the WLAN AP's current performance or data rate, the excepted range of the WLAN AP, if there is VoIP available, and GPS coordinates or other physical location indicators.

WLANLs also allow better management of active wireless sessions. If a mobile wireless device has an active session using a WWAN air interface, the mobile wireless device may monitor the bandwidth and error rate of the interface and compare it with WLAN APs that are in range. If the WWAN interface falls behind a selected metric such as error rates or data transfer rates, the device can enable or force a session hand-off to the better interface.

### BRIEF DESCRIPTION OF THE DRAWINGS

FIG. 1 is an illustration of a wireless network including a plurality of WLAN APs.

FIG. 2 is a block diagram of a wireless device in accordance with the present disclosure.

FIGS. 3A-3C are flow diagrams showing aspects of WLANL generation and updating.

FIGS. 4-5 are flow diagrams showing WLANL use.

### DETAILED DESCRIPTION

Persons of ordinary skill in the art will realize that the following description of the present invention is exemplary and not in any way limiting. Other embodiments of the invention will readily suggest themselves to such skilled persons who also have the benefit of the present disclosure.

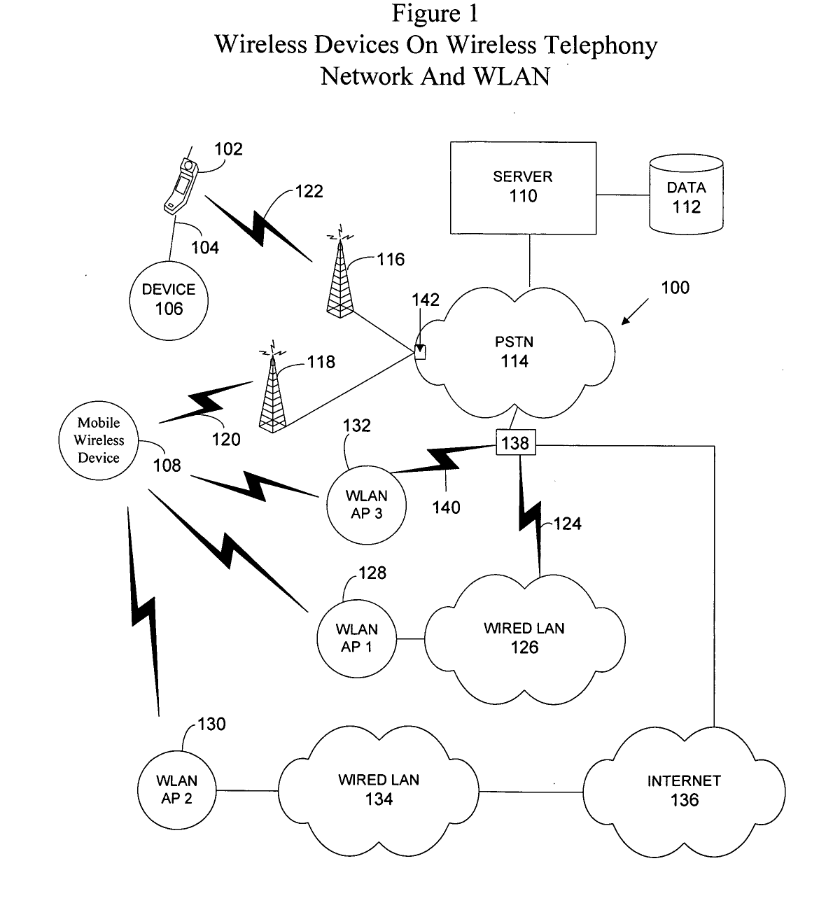

Referring generally to the drawings, for illustrative purposes the present invention is shown embodied in FIG. 1 through FIG. 5. It will be appreciated that the apparatus may vary as to configuration and as to details of the parts, and that the method may vary as to details and the order of any acts, without departing from the inventive concepts disclosed herein.

The word “exemplary” is used to mean “serving as an example, instance, or illustration.” An embodiment described as “exemplary” is not necessarily to be construed as preferred or advantageous over other embodiments.

The term “computer readable medium” is used to refer to any media used to provide, hold, or carry executable instructions (e.g., software, computer programs) usable for execution by a central processing unit (CPU, microprocessor, DSP, or any other logic device capable of executing instructions). Media includes, but is not limited to, memory readable by the CPU that can be local, remote, volatile, non-volatile, removable, etc., and can take any suitable form such as primary memory, secondary memory including disks, removable cards or flash, remote disks, etc. Computer readable medium further includes any means for providing executable code, programming instructions, and/or decision inputs to a CPU used in a wireless communication device, base station, or other entity with a CPU. The executable code, programming instructions, decision inputs, etc., when executed by a CPU is used to cause the CPU to enable, support, and/or perform the inventive features and functions described herein.

Referring to FIG. 1, shown is a high level block diagram of an example wireless telephone network 100, usable with mobile wireless communications devices 102 and 108. The wireless connections are shown as links 120 and 122. For the purposes of the present disclosure, mobile wireless communications devices can be any mobile wireless device that can send and receive signals from two sources, one being a WWAN air interface and the other being a WLAN air interface. For example, the device could be a multi-mode cell phone, a PDA, a portable computer, a mobile printer/fax machine, etc. Other devices will come to the mind of a person skilled in the art who also has the benefit of the present disclosure.

Also shown is device 106 operably connected to mobile wireless device 102. Device 106 may be a support device to device 102 (i.e., a Bluetooth speaker/mike, in which case connection 104 would be wireless) or may have the ability to interact with network 100 through mobile wireless device 102, being a mobile wireless device in its own right. Communication network 100 comprises a plurality of base stations shown as base stations 116 and 118. Each base station is connected to the PSTN (public switched telephone network), and further comprises the typical servers (110) and associated databases (112) in use for PSTNs.

Typically network cloud 114 is a combination of private networks, including a wireless carrier network and a traditional PSTN (landline) network. In that regard, base stations 116 and 118 communicate with a base station controller (BSC) or a mobile switching center (MSC) which then interfaces with a BSC, represented generally as box 142. Box 142 will then act as the interface to a PSTN. Network cloud 114 is intended to represent the overall network functionality from the base stations into the PSTN, including the components that interface with the base stations and the traditional PSTN components.

Mobile wireless device 108 may also connect to WLANs. Shown are three WLAN APs, AP 128, AP 130, and AP 132 (illustrated in the figure as AP 1, AP 2, and AP 3 respectively). AP 128 is connected to a wired LAN 126, which is connected to packet data servicing node (PDSN) 138, which is connected to PSTN 114. In other embodiments, LAN 126 may be standalone. AP 130 is connected to LAN 134, which in turn is connected to the Internet 136 and can thereby access network 114. Illustrated is a connection through PDSN 138, however other embodiments, especially in the future, may allow a different connection into PSTN 114. AP 132 is connected to PSTN 114 using PDSN 138.

Server 110 can be implemented as a single computer, as a plurality of servers logically arranged to provide data and/or instruction sets to mobile wireless devices as requested, or server 110 could be operably connected to a mobile wireless device and to execute instructions received from mobile wireless devices. In the illustrated embodiment, server 110 is coupled with a data storage area 112 that may house a plurality of executable interfaces and a set of server operation codes, mobile wireless device operation codes and executable instructions corresponding to the server operation codes, databases (including any needed for the WLAN AP WLANLs discussed below). Server 110 also represents the plurality of databases needed to support proper functioning of network 100. No specific connectivity is implied by the diagram for these database servers; it is generally representative of any workable implementation and includes databases that are available to a mobile wireless device from the wireless network as well as any that are available through a PSTN.

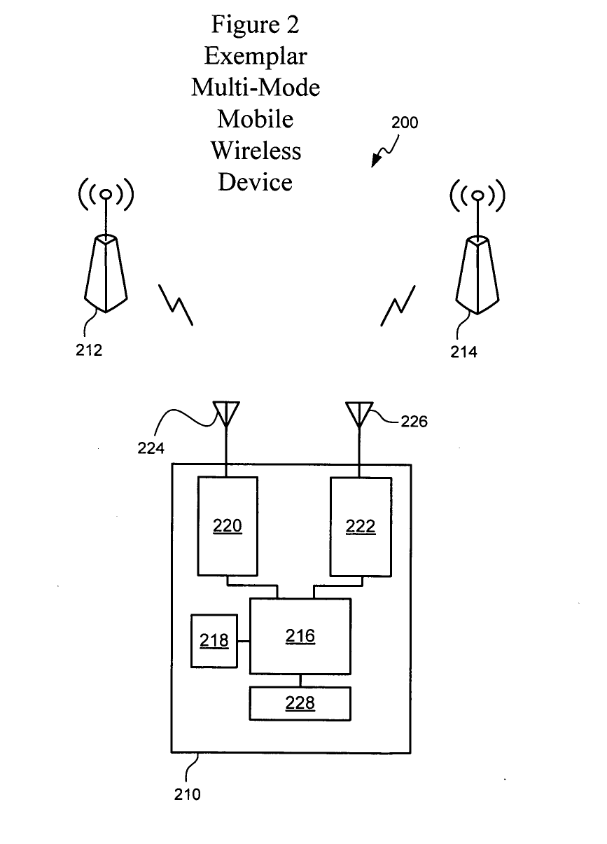

Referring to FIG. 2, there is shown network arrangement 200 including exemplary multi-mode mobile wireless device 210. Multi-mode mobile wireless device 210 may be a mobile phone or any other mobile wireless device capable of communicating over at least two air interfaces, including one WLAN air interface. According to one particular embodiment, multi-mode mobile wireless device 210 is capable of communicating to network 212 using any WWAN technology, including but not limited to cdma2000, Global System for Mobile Communications (GSM), or WCDMA. Multi-mode mobile wireless device 210 is further capable of communicating over a WLAN interface 214 in accordance with IEEE 802.11 a/b/g or any other WLAN protocol.

Note that cdma2000 includes both circuit switched networks, cdma2000 1×, and packet switched networks, cdma2000 HRPD or 1×EV-DO. The presently disclosed inventive concepts are not limited to circuit switched WWANs over network 212.

Multi-mode mobile wireless device 210 comprises processor 216 coupled to a memory 218 and to first transceiver 220 and second transceiver 222. Programming is stored in memory 218 and executed by processor 216 for the operation of multi-mode mobile wireless device 210. First transceiver 220 is coupled to antenna 224 for communication with network 212, and second transceiver 222 is coupled to antenna 226 for communication with network 214. Processor 216 is also coupled to interface 228, which may further be coupled to one or more user-interface (UI) devices (not shown), such as a display device, input keys, a microphone, and a speaker, for example. WLANLs are typically kept in memory 218 and processed by processor 216. Note that memory 218 includes all types of memory, including volatile and non-volatile components, removable, etc. Current technology is used in this exemplar mobile wireless device; if future transceiver and antenna designs allow (for example) the use of a single combined antenna unit for multiple access, that and any other evolving mobile wireless device configuration is contemplated as working with the inventive concepts disclosed herein.

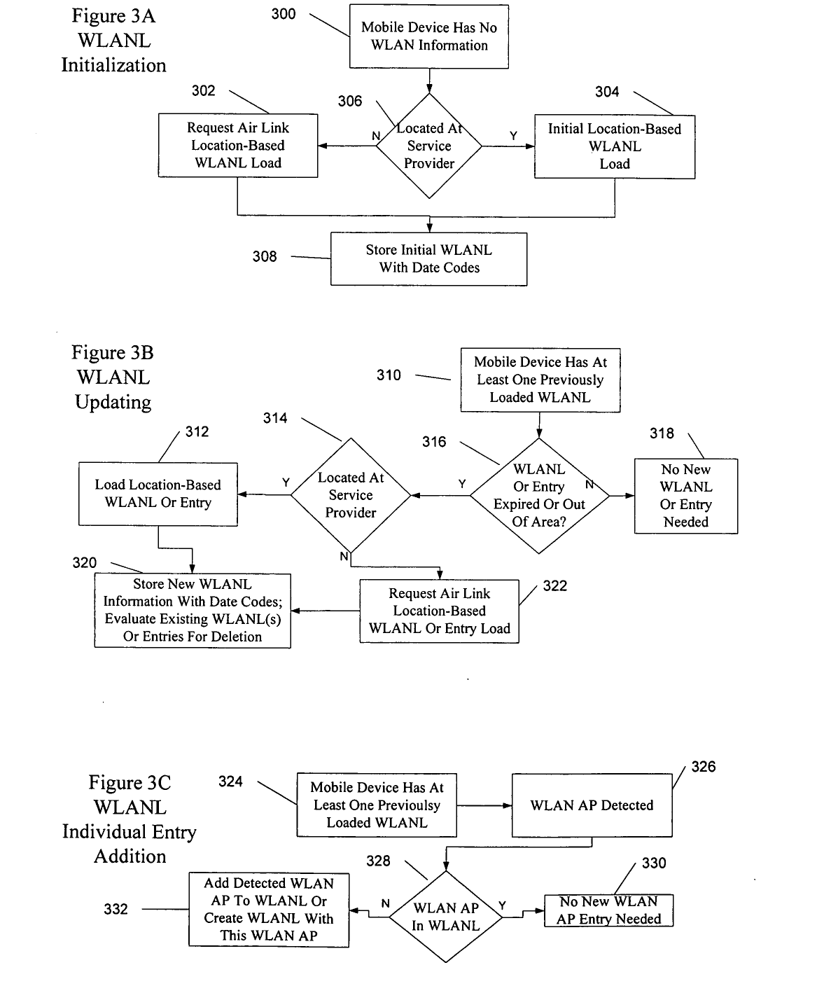

Referring to FIG. 3A, illustrated is a series of actions corresponding to one way of initializing a WLANL in accordance with the inventive concepts disclosed herein. Box 300 shows the state of a mobile wireless device when its localized (location specific)

WLANL for use in accordance with the presently disclosed inventive concepts is not populated. This may be the case when a mobile wireless device is new, or perhaps the previous WLANLs were considered too dated and were deleted. The mobile wireless device may also have been re-initialized for some reason (for a new user, for example), so any existing WLANL data was erased. In these and other cases, there will be no existing WLANLs. Continuing into decision diamond 306, the mobile wireless device detects if it is connected to a local data source. A local data source includes any source of WLANLs where the location of the mobile wireless device is known due to the connection, rather than based on location data derived from the mobile wireless device. This will typically be at a service provider's store. The connection at the location may be wired or wireless. Further embodiments include, but are not limited to, loading WLANLs from memory cards or any other computer readable media, and loading or using WLANLs loaded or retrieved from removable user identity modules (R-UIMs).

The concept of a local data source further includes loading WLANLs from an on-line source. The mobile wireless device may be directly connected to the internet, or, may be connected to a PC which is on-line. This could also be done by a user at home by connecting to a website that has WLANLs available for downloading. In one embodiment, the location of the mobile wireless device is used to load applicable WLANLs, where the location of the network connection would be used as the default location to determine which WLANL(s) to load.

The local data source may be public or private. The example in the last paragraph was a private local data source. Fully contemplated herein are public local data sources as well. For example, a city may wish to provide public sources of WLANs in order to attract and encourage e-business and e-aware-tourists.

The actions corresponding to box 304 are to download a WLANL (described further below) according to the location of the mobile wireless device. The location may be known to the required level of granularity based on the mobile wireless device's cell connection. The location of the cell to which the device is communicating is expected to be one of the more common ways of determining what WLANL, or set of WLANLs, to provide to the device. The location may also be determined by using GPS or other locating technologies. The location may be determined by the mobile wireless device alone, by the wireless network, or any combination.

The network can determine which location-based WLANL to send to the mobile wireless device in any number of ways. In one embodiment, the network will supply location-based WLANLs using the cell or cells broadcasting the information to the mobile wireless device. GPS or other location data will be in the WLANL entries for the WLAN APs. The device's current location may be determined by the device either with, or independently from, the network. The mobile wireless device will then use its location information in combination with location information in the WLAN entries to make WLAN AP search decisions. In another embodiment, location-based WLANL(s) are provided to a mobile wireless device using location information provided by the mobile wireless device to the wireless network. It is understood that any way of specifying location may be used, including but not limited to GPS or AGPS.

In another embodiment, the mobile wireless device can have a local WLANL loaded at a service center or sales center. In these cases it is expected that the tool used to load the local WLANL would not, during use on a customer's mobile wireless device, be connected to the service provider's network. Rather, the tool would be a have a standard local WLANL in its memory it would transfer to the mobile wireless device. The tool may be periodically updated over the carrier's network, or may be connected to a server providing the latest WLANLs when not in use.

In yet another embodiment, the mobile wireless device can have a WLANL loaded over the internet, being connected through an air interface or through a wired connection to the owner's computer. The owner would select from a set of lists on a website, alternatively, the mobile wireless device sends location information and the website selects the best fit WLANL.

In a further embodiment, the user will be presented with a selection of locations that may include locations other than the user's current location. These other locations could be locations the user is planning to visit, other locations the user frequents, or the phone may need primary location WLANLs loaded away from the primary location. Whatever the reason, a user either selects or inputs a geographical location and WLANLs associated with that location are downloaded.

Continuing with FIG. 3A, if the answer in decision diamond 306 is no, then the “N” exit is taken to box 302. The actions corresponding to box 302 are those associated with retrieving a WLANL over an air interface. No limitation on the specific mechanisms used in the air interface are implied in the following description. In one embodiment the mobile wireless device will make a request to its carrier through the local cell. In response, the carrier will supply a location aware WLANL. The location data used to determine which WLAN(s) to provide can come from the cell through which the mobile wireless device is communicating, through a GPS reading from the mobile wireless device, or any other suitable technology. The location data is provided to a provisioning server, which responds with the location-based WLAN(s). In another embodiment, the mobile wireless device will listen to a designated channel over which WLANLs for WLANs are periodically broadcast.

After the mobile wireless device has received WLANL information, box 308 is entered. The actions corresponding to box 308 include those needed to establish a date or time/date stamp for either the entire local WLANL, for each entry in the WLANL, or for both (different implementations will differ on how to store and use date or time/date data associated with each local WLANL). This results in the mobile wireless device having a WLANL for use in searching for, and using, WLAN APs.

FIG. 3B illustrates updating an existing WLANL. Box 310 shows the mobile wireless device's current state, having at least one existing WLANL. Many embodiments will employ a plurality of WLANLs. Examples of multiple lists include, but are not limited to, one for each area through which the mobile wireless device has recently traveled, WLANLs corresponding to multiple WLANL loads where older WLANLs have not yet been purged, or, the existence of different types of WLANLs.

WLANLs may be considered different types depending on their origin. One type of WLANL may be loaded from a data source, a second type may be generated by a user, and a third type may be generated by the mobile wireless device. In one embodiment user generated WLANL(s) cannot be purged, overwritten, or otherwise changed due to the loading or changing of a data source WLANL. This protects user WLANLs from accidentally being lost if, when loading WLANLs or WLANL entry updates from a data source, the amount of downloaded data exceeds current memory stores. Other embodiments may include ordering or weighting different types of WLANLs to enable WLANL management software to determine how to prioritize resource usage between WLANL types, as well as between multiple WLANLs of the same type. WLANL management software will also address any other needed WLANL management tasks.

Box 310 is left for decision diamond 316. The actions taken from decision diamond 316 are those associated with determining if one of more of the WLANLs needs updating, based on date/time information in the WLANL and/or its entries.

In one embodiment, updating a WLANL will primarily depend of two pieces of data. One is the date, or time/date, associated with either the WLANL as a whole or with an entry. The other is the current location of the mobile wireless device. The WLANL management software (any combination of software code or instructions that manages the WLANLs, whether or not co-located in source code) can use any available means to determine its location. In one embodiment the mobile wireless device has GPS location capabilities so can determine where it is. In other embodiments the mobile wireless device may rely on data from a cell or the network to which it is connected to determine its location. Any way of determining location works with the disclosed inventive concepts.

The WLANL management software may use the location information alone to make an initial decision if it needs an update. If the mobile wireless device is now in a location outside the range of the existing WLANLs, the mobile wireless device decides it must update the WLANL. If the mobile wireless device is in a physical area covered by (associated with) one of the existing WLANLs, the mobile wireless device (the software in the mobile wireless device) looks at the date information it has. Different implementations will handle the date information differently. The time-delta (difference between the current date or time/date, and the one associated with the WLANL or WLANL entry) used to delete existing local WLANLs will depend on the mobile wireless device's sophistication and environment. The simplest embodiments will have a single comparison, where anything with a time-delta beyond a certain value will be erased. Other embodiments will employ additional criteria, such as when the last time a WLAN AP was accessed or detected. An older entry in a WLANL may still be good. Last access or last detection information can be stored with the WLANL entry and used to make a finer-granularity decision than the initial entry date alone. An older entry date coupled with a recent detection date or use date will allow the WLANL entry, or WLANL list, to be left as-is. Alternatively, a WLANL entry that has not been detected since the WLANL list was created, coupled with the mobile wireless device's location data which indicates it was within the expected range of the WLAN AP, may be deleted. Other criteria may be used as well.

Some implementations will also allow a user to set some preferred defaults. It is expected that some embodiments will include user-settable flags that allow the user to tell the mobile wireless device to keep a WLANL or WLANL entry until the user deletes it. This is useful when a user has a set of known WLAN APs that may be periodically down, but which the user plans on using when available. Other scenarios when it would be useful to keep WLAN AP information from being purged will become clear to practitioners in the art who also have the benefit of the present disclosure.

In another embodiment, WLANLs or individual WLANL entries are flagged for deletion when memory must be recovered, but otherwise may be left in place.

If the WLANL and its entries are correct for the mobile wireless device's location, and are not deemed to be outdated or unusable, the no exit is taken from decision diamond 316 to box 318. Box 318 corresponds to the mobile wireless device not needing an update before using the existing WLANL(s).

If the decision in decision diamond 316 is that at least some updating of a WLANL is needed, which may include the entire WLANL or an entry, then decision diamond 316 is left for decision diamond 314. The actions corresponding to decision diamond 314 are similar in functionality to those in 306 above; the mobile wireless device detects if it is connected at a service provider's location. Currently this includes connecting the mobile wireless device using a wired port; however, all interfaces are fully contemplated herein including but not limited to Bluetooth, IR, removable or plug-in memory, etc. If this is the case, decision diamond 314 is left for box 312. The action associated with box 312 are those needed to load a localized WLAN-aware WLANL (a complete list or updated entries).

If, at decision diamond 314, the answer is no then box 322 is entered. The actions corresponding to box 322 are those associated with updating or retrieving WLANL information (a complete WLANL or specific entries) over an air interface. Similarly to box 302 above, the mobile wireless device updates its information (makes a specific request which is answered, listens to a designated channels, etc.).

Continuing into box 320, the newly acquired data (entire WLANL, updated entries, etc.) is stored in a manner associated with its downloaded date or time/date. It is expected that a typical embodiment will associated an entire WLANL with a location, but it is contemplated to store location data with each WLANL entry. In that case, it is expected that the location associated with the entire WLANL is more generalized, whereas the location information stored with an individual WLANL entry will be specific to that entry. The size of cells and other considerations will be taken into account when decided at what granularity location information will be stored.

One embodiment of the presently disclosed inventive concepts will keep location information at more than one logical location in a WLANL. One of those locations will be within individual WLAN AP entries. Individual WLANL AP entry information may be provided by a carrier or a provider, or may be updated by the mobile wireless device itself. In the later case, an update of a single WLANL AP entry may be desirable upon detection of a WLAN AP that is new (not in any current WLANL), or by detection of an AP already in the WLANL. If the AP is new, the mobile wireless device may enter it into an existing WLANL or may create a new WLANL for this entry. How the mobile wireless device decides to place the new entry is dependent on each implementation, but it will usually be based on the current location of the mobile wireless device and location information associated with a WLANL (not an entry). This includes the possibility of using a default general WLANL if no location information is currently available. If the WLAN AP entry already exists, the information may be updated showing a new last-detection time stamp or other information.

A mobile wireless device may create a new WLANL to hold information about a newly detected WLAN AP, if the location information for the detected WLAN AP is outside the area defined by an existing WLANL. A single WLAN AP's information may constitute a WLANL, if it is the only entry for a region or location. In addition, any method may be used to organize WLANLs, single WLAN APs, etc. For example, they may be stored in a single database, where the database may be anything from a simple flat file with character delimited records and fields, or may be a fully functional relational database. There may be separate instances of a database; or, the WLANLs may be implemented in other ways such as complex data types or data structures. Any method may be used.

FIG. 3C illustrates one embodiment of updating or adding a single WLANL entry. Box 324 corresponds to a mobile wireless device that is functioning in an environment. It is expected that the mobile wireless device will have at least one WLANL at this time. Continuing into box 326, the mobile wireless device detects a WLAN AP.

Continuing into decision diamond 328, the mobile wireless device checks to see if the detected WLAN AP has an entry in an existing WLANL. If there is an existing entry, decision diamond 328 is left for box 330. The actions corresponding to box 330 vary according to the implementation, but in any case no new WLANL WLAN AP entry is created. In one embodiment the mobile wireless device will update a “detected” field with the current date or time/date for this entry.

If the WLANL(s) associated with the mobile wireless device's current location do not have an entry corresponding to the presently detected WLAN AP, decision diamond 328 is left for box 332. The actions corresponding to box 332 include those needed to add the detected WLAN AP to a database in the mobile wireless device. If the mobile wireless device is in a location associated with existing WLANL, then a new entry is made to the existing location-specific WLANL for this WLAN AP (including date of entry data). If the mobile wireless device does not have a WLANL corresponding to this location, the mobile wireless device creates a WLANL and a single entry therein, corresponding to this WLAN AP.

In addition to the above-mention properties, entries in the WLANL may also have the following:

WLAN AP SSID

Frequency Channel

Authentication Information

Provider/Private

WLAN Type

Current Data Rate

Region And/Or Cell Size

VoIP Availability

Bandwidth Availability

Other data specific to an AP may readily be incorporated into the entries as well. The present disclosure fully contemplates adding additional information for higher-end embodiments, while minimizing the information kept for lower-cost embodiments.

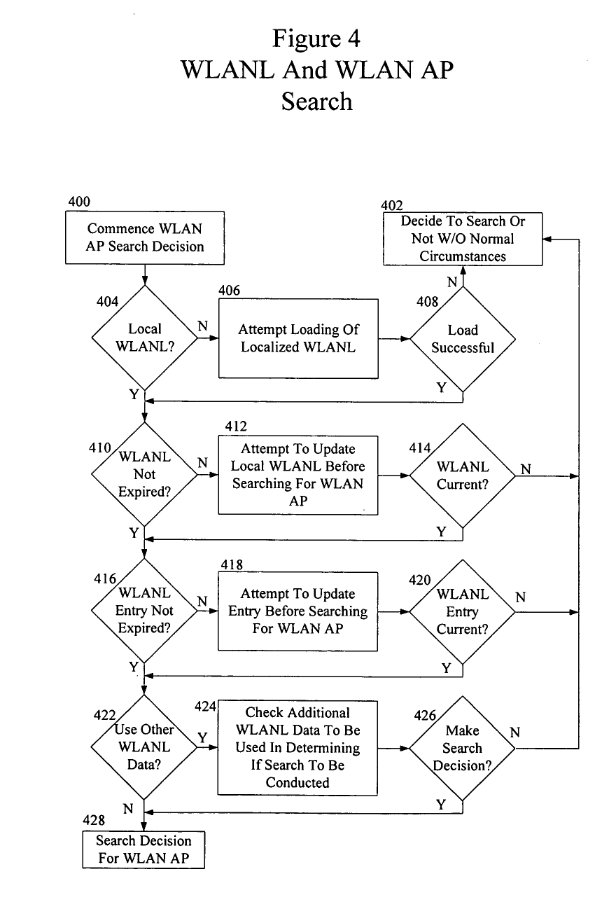

FIG. 4 illustrates the use of the localized WLAN AP WLANL to efficiently find APs. Box 400 corresponds to the start of the overall decision process on searching for a WLAN AP. It is assumed the state of the mobile wireless device is that it is not searching for an AP, but that something has triggered the decision process. The trigger event may be as simple as a timer, but may also be a more sophisticated trigger or be made up of a plurality of trigger events. An exemplar simple timer trigger would be to start the search check algorithm each time a predefined number of time increments have elapsed. Another trigger includes the phone detecting it has moved to a new location (needs to look at a different WLANL than the WLANL last used). Yet another trigger depends on comparing the mobile wireless device's current location with location data in the WLANL entries; when it appears closer than previously detected, initiate the search check algorithm before actually conducting the WLAN AP search. A further trigger might be the user initiating a high data-rate application. Any trigger is usable with the presently disclosed inventive concepts.

Moving into decision diamond 404, the mobile wireless device determines if it has a local WLANL at all. If the answer is no, then decision diamond 404 is left for box 406. The actions corresponding to box 406 include all those associated with attempting to load a location-based WLANL. Box 406 is left for decision diamond 408, which determines if the load was successful. If a local location-based WLANL was acquired, then decision diamond 408 is left for decision diamond 410. If no location-based WLANL was loaded, the no exit is taken from decision diamond 408 to box 402.

The actions corresponding to box 402 are any taken which correspond to a corresponding non-optimal state for the currently resident WLANs, or their entries. In the case of 402 being entered from decision diamond 408, there is no local WLANL. The actions therefore correspond to any made in light of the lack of a local WLANL, which may include but are not limited to: no search; a “default” searching algorithm used when no local WLANL AP information is available; or, any other related action.

Continuing with decision diamond 410, the mobile wireless device checks date-related information in the WLANL. If the date-related or age-related information is determined to be expired, decision diamond 410 is left for box 412. The actions corresponding to box 412 include any taken in an attempt to load a newer version of the WLANL. Box 412 is left for decision diamond 414.

Decision diamond 414 correspond to assessing if the attempt to update the WLANL was successful. If not, the no exit is taken from decision diamond 414 and box 402 entered. The actions corresponding to box 402 are any taken in light of the expired WLANL information. Actions include, but are not limited to, not searching or using the expired information to determine if a search should be made.

If the WLANL was updated in box 412, the yes exits is taken from decision diamond 414 to decision diamond 416. Decision diamond 416 corresponds to checking any age or date related information in individual WLAN entries. If individual entries do not have date or age information, decision diamond 416 is left for decision diamond 422. If the age related information associated with one of more individual entries of the WLANL are beyond a specified expiration time, then decision diamond 416 is left for box 418. The actions corresponding to box 418 include any taken by the mobile wireless device to attempt to update the WLANL entries. Box 418 is left for decision diamond 420.

Decision diamond 420 corresponds to assessing if the update was successful. If it was not, the no exit is taken and box 402 entered. The actions corresponding to box 402 are any associated with the expired WLANL entries. Actions may include, but are not limited to, not searching or decided to search using the expired information in the WLANL.

If the update in box 418 was successful, the yes exist is taken from decision diamond 420 to decision diamond 422. Decision diamond 422 corresponds to the use of other WLANL information. If the answer is no, no other WLANL information be used to search for a WLAN AP, then the no exit is taken from decision diamond 422 to box 428.

The actions corresponding to box 428 are the use of the WLANL information to decide if a search is to be conducted. The information used includes the location information in the WLANL for a WLAN AP, as the age related information is known to be current at this point in the decision process.

If the decision at decision diamond 422 is yes, other information will be used, then the yes exit is taken from decision diamond 422 into box 424. The actions corresponding to box 424 includes the retrieval of any additional information to be used in making a decision to search. The actions may also include further processing of additional information. Exemplar additional processing may include, but is not limited to, the use of WLANL priority information. The priority information may be based on the type of WLANL being used as compared to other WLANLs that may also be local, or the priority of each WLANL AP entry as compared to other WLANL entries. Box 424 is left for decision diamond 426.

Decision diamond 426 correspond to the assessment made using the other information. If the assessment results in a yes decision, that is, a search should be made based on this additional information, then the yes exit is taken from decision diamond 426 to box 428. The actions associated with box 428 are those described above. If the assessment at decision diamond 426 is no, then the no exit is taken to box 402. The actions associated with box 402 are any resulting from the decision to not search based on other information in box 424. These actions include, but are not limited to, doing no search or overriding the decision in 424 and deciding to search in spite of the information.

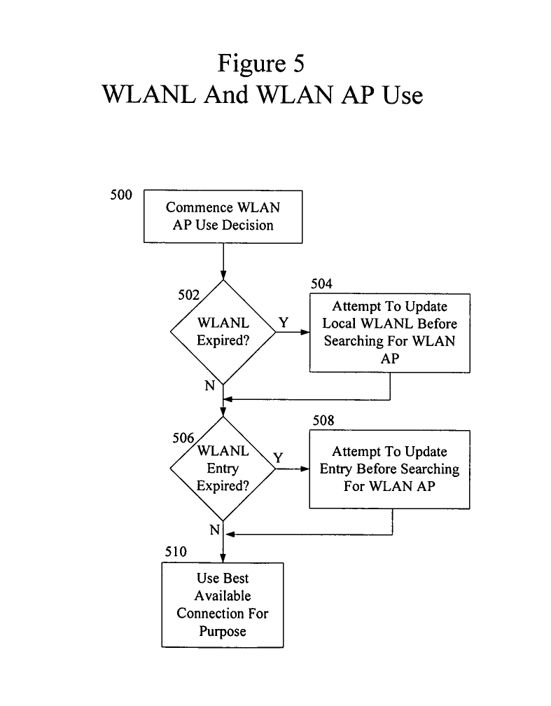

FIG. 5 illustrates the use of the WLANL in managing active connections. The state of the mobile wireless device in box 500 is that of having an active session. The active session may be over a WWAN air interface or a WiFi air interface. On a regular basis, the mobile wireless device checks the status of its WLANL. This corresponds to entering decision diamond 502. If the WLANL is out-of-date, decision diamond 502 is left for box 504. Otherwise decision diamond 502 is left for decision diamond 506. The actions corresponding to box 504 include those described earlier when the mobile wireless device uses an available interface to update its WLANL. Box 504 is left for decision diamond 506.

Decision diamond 506 corresponds to checking for age related information in individual WLANL entries. If the information is checked and the WLANL entry is deemed expired, decision diamond 506 is left for box 508. Otherwise, decision diamond 506 is left for box 510. The actions corresponding to box 508 are similar to those described above for box 502, as applied to updating individual entry information and not just locating an entire WLANL. Upon success or failure, box 508 is left for box 510.

Box 510 corresponds to the actions taken to use the best available air interface for the operating session. Note that algorithms associated with 500 to 506 or 508 may be run completely independently of the actions associated with box 510. Upon reaching 510, the mobile wireless device uses the data in the WLANL, plus a real-time assessment of the current load capabilities of each interface, to determine if (i) the best interface is in use, and (ii) if not, trigger a handoff of the session from one interface to another. An exemplar situation is when the WWAN interface signal is weak, or there is insufficient available bandwidth. The mobile wireless device checks the status of the WiFi air interface, which may include its data rate, availability, if it supports VoIP, the service provider, or any other parameters, and decides if the current session should be switched to the WiFi connection.

From the above description of exemplary embodiments of the invention, it is manifest that various techniques can be used for implementing the inventive concepts herein. Moreover, while the inventive concepts have been described with specific reference to certain embodiments, a person of ordinary skill in the art who also has the benefit of the present disclosure would recognize that changes could be made in form and detail without departing from the spirit and the scope of the inventive concepts disclosed. Thus, described exemplary embodiments are to be considered in all respects as illustrative and not restrictive.

What is claimed is:

1. A method for using a wireless local area network list (WLANL) in a mobile wireless device, the WLANL having an area associated with it, the method comprising:
identifying the mobile wireless device's location;
checking age related information associated with the WLANL;
referencing wireless LAN access point (WLAN AP) information in the WLANL, the WLANL AP information comprising AP location information; and
using the referenced information in deciding to start a search for a WLAN AP.

2. The method of claim 1 where the WLAN AP data further comprises one or more of: a WLAN AP SSID; frequency information; encryption information, provider information; WLAN type information; the WLAN AP's data rate; excepted range of the WLAN AP; VoIP availability; and, the AP's location.

3. The method of claim 1 where the age information is associated with each entry of the WLANL.

4. The method of claim 1 where the age information is associated with the WLANL.

5. The method of claim 2 where the referenced WLAN AP information comprises location information, the method further comprising:
calculating a distance from the WLAN AP to the mobile wireless device.

6. The method of claim 1 further comprising:
adding a WLAN AP entry into the WLANL when the mobile wireless device detects a WLAN AP having no corresponding entry in the WLANL.

7. The method of claim 1 further comprising:
generating a request for a location-based WLANL.

8. A method for managing an active session between a wireless wide area network (WWAN) air interface and a wireless LAN (WLAN) air interface using a wireless local area network list WLANL in a mobile wireless device, the WLANL having an area associated with it, the method comprising:
identifying the mobile wireless device's location;
referencing area and carrier data in the WLANL using a WLAN AP entry therein, to identify a WLAN AP enablable for a session handoff;
locating the WLAN AP;
evaluating each air interface for suitability for the current session;
selecting a best air interface; and
enabling a handoff between air interfaces if said best air interface is not currently the active session interface.

9. The method of claim 8 where the WLAN AP data further comprises one or more of: a WLAN AP SSID; frequency information; encryption information; WLAN type information; the WLAN AP's current performance or data rate; excepted range of the WLAN AP; VoIP availability; and, AP location information.

10. The method of claim 8 further comprising:
determining age information associated with the WLAN AP entry in the WLANL.

11. The method of claim 8 further comprising:
determining age information associated with the WLANL containing the WLAN AP entry.

12. The method of claim 9 where the referenced WLAN AP information comprises AP location information, the method further comprising:
calculating a distance from the WLAN AP to the mobile wireless device.

13. The method of claim 8 further comprising:
adding a new WLAN AP entry into the WLANL when the mobile wireless device detects a WLAN AP having no corresponding entry in the WLANL; and
using the new entry as the enablable WLAN AP.

14. A mobile wireless device comprising:
a wireless wide area network (WWAN) interface;
a wireless LAN (WLAN) interface;
a CPU and a memory in operable communication with said interfaces;
software executable on said CPU and memory enabled to use a localized preferred roaming list (WLANL);
where the WLANL comprises at least one WLAN AP entry, the entry comprising location information, and the WLANL having age information.

15. The mobile wireless device of claim 14 where the WLAN AP entry further comprises one or more of: a WLAN AP SSID; frequency information; encryption information; WLAN type information; the WLAN AP's current performance or data rate; excepted range of the WLAN AP; VoIP availability; AP location information; and, provider information.

16. The mobile wireless device of claim 14 where the age information comprises age information associated with each WLAN AP entry in the WLANL.

17. The mobile wireless device of claim 14 where the age information comprises age information associated with the WLANL containing the WLAN AP entry.

18. The mobile wireless device of claim 15 where the WLAN AP information comprises AP location information, and where the mobile wireless device is configured to allow a calculation of a distance from the WLAN AP to the mobile wireless device.

19. The mobile wireless device of claim 14 further configured to allow the addition of a new WLAN AP entry into the WLANL when the mobile wireless device detects a WLAN AP having no corresponding entry in the WLANL.

20. The mobile wireless device of claim 14 further configured to generate a request for a location-based WLANL.
